(19) United States
(12) Patent Application Publication
(10) Pub. No.: US 2016/0187548 A1
(43) Pub. Date: Jun. 30, 2016

(54) POLARIZING FILM AND DISPLAY DEVICE INCLUDING THE POLARIZING FILM

(71) Applicants: SAMSUNG ELECTRONICS CO., LTD., Suwon-si (KR); SAMSUNG SDI CO., LTD., Yongin-si (KR)

(72) Inventors: Dong Yun LEE, Suwon-si (KR); Feifei FANG, Suwon-si (KR); Boreum JEONG, Daejeon (KR); Beom Seok KIM, Seoul (KR); Seong-Jun YOON, Yongin-si (KR); Myung Sup JUNG, Seongnam-si (KR)

(21) Appl. No.: 14/722,296

(22) Filed: May 27, 2015

(30) Foreign Application Priority Data
Dec. 31, 2014 (KR) 10-2014-0195865

(51) Int. Cl. G02B 5/30

(52) U.S. Cl. CPC G02B 5/305

(57) ABSTRACT

A polarizing film includes a melt-elongation film including a polyolefin selected from a polyethylene-polypropylene copolymer, a mixture of polyethylene and polypropylene, a mixture of polypropylene and a polyethylene-polypropylene copolymer, and a mixture thereof, and a dichroic dye, wherein the polyolefin includes about 0.15 to about 3 percent by weight of ethylene groups.

### CROSS-REFERENCE TO RELATED APPLICATION

This application claims priority to Korean Patent Application No. 10-2014-0195865, filed in the Korean Intellectual Property Office on Dec. 31, 2014, and all the benefits accruing therefrom under 35 U.S.C. §119, the content of which is incorporated herein in its entirety by reference.

### BACKGROUND

1. Field

A polarizing film and a display device including the polarizing film are disclosed.

2. Description of the Related Art

A display device such as a liquid crystal display (LCD) and an organic light emitting diode (OLED) includes a polarizing plate attached to the outside of a display panel. The polarizing plate only transmits light of a specific wavelength and absorbs or reflects light of any other wavelength, thereby controlling the direction of incident light on the display panel or light emitted from the display panel.

The polarizing plate generally includes a polarizer and a protective layer for the polarizer. The polarizer may be formed of, for example, polyvinyl alcohol (PVA), and the protective layer may be formed of, for example, triacetyl cellulose (TAC).

However, the process of fabrication of the polarizing plate including the polarizer and the protective layer is not only complicated and expensive, but also results in production of a thick polarizing plate which leads to an increased thickness of a display device. Accordingly, there remains a need for a polarizing film that does not require a protective layer.

Therefore, a technology to manufacture a polarizing film by melt-blending a polymer with a dichroic dye and elongating the resultant composition has been suggested. However, since properties of a polymer have an effect on properties of a polarizing film, there remains a need for controlling properties of the polymer.

### SUMMARY

An embodiment provides a polarizing film having high polarizing efficiency and transmittance.

Another embodiment provides a display device including the polarizing film.

Yet another embodiment provides a composition for a polarizing film.

According to an embodiment, a polarizing film includes a melt-elongation film including a polyolefin selected from a polyethylene-polypropylene copolymer, a mixture of polyethylene and polypropylene, a mixture of polypropylene and a polyethylene-polypropylene copolymer, and a mixture thereof, and a dichroic dye, wherein the polyolefin includes about 0.15 to about 3 percent by weight (wt %) of ethylene groups.

The polyolefin may include about 0.3 to about 2 wt %, for example about 0.5 to about 2 wt %, of ethylene groups.

The polyolefin may have a melt flow index (MFI) of about 3 g/10 min to 11 g/10 min.

The polyolefin may be a mixture of polypropylene and a polyethylene-polypropylene copolymer, the polypropylene (PP) may have a melt flow index of about 3 g/10 min to about 9 g/10 min, and the polyethylene-polypropylene copolymer (PE-PP) may have a melt flow index of about 5 g/10 min to about 11 g/10 min.

The polyolefin may include the polypropylene and the polyethylene-polypropylene copolymer in a weight ratio of about 1:9 to about 9:1.

The dichroic dye may be dispersed in the polyolefin, and the polyolefin may be elongated in a uniaxial direction at an elongation rate of about 400% to about 1,200%.

The dichroic dye may be included in an amount of about 0.1 to about 10 parts by weight, for example about 0.5 to about 5 parts by weight, based on 100 parts by weight of the polyolefin.

The polarizing film may have haze ranging from less than or equal to about 5%, for example about 0.5% to about 3.5%, for another example about 0.5% to about 2.5%.

The polarizing film may have a degree of crystallinity of about 30% to about 45%, for example about 35% to about 42%.

The polarizing film may have polarizing efficiency of greater than or equal to about 98%, for example about 98% to about 99.9% at light transmittance of greater than or equal to about 42%.

According to another embodiment, a display device including the polarizing film is provided.

According to yet another embodiment, a composition for a polarizing film includes a polyolefin selected from a polyolefin selected from a polyethylene-polypropylene copolymer, a mixture of polyethylene and polypropylene, a mixture of polypropylene and a polyethylene-polypropylene copolymer, and a mixture thereof, and a dichroic dye, when the polyolefin includes about 0.15 to about 3 wt % of ethylene groups.

The polyolefin may include about 0.3 to about 2 wt %, for example about 0.5 to about 2 wt % by weight, of ethylene groups.

The composition for a polarizing film may have a solid content of greater than or equal to about 90 wt % by weight.

The composition for a polarizing film may not include a solvent.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view showing a polarizing film according to an embodiment;

FIG. 2 is a cross-sectional view showing a liquid crystal display (LCD) according to an embodiment; and

FIG. 3 is a cross-sectional view of an organic light emitting diode (OLED) display according to an embodiment.

### DETAILED DESCRIPTION

Exemplary embodiments will hereinafter be described in detail, and may be easily performed by those who have common knowledge in the related art. However, this disclosure may be embodied in many different forms and is not construed as limited to the exemplary embodiments set forth herein; rather, these embodiments are provided so that this disclosure will fully convey the scope of the disclosure to those skilled in the art. Thus, in some exemplary embodiments, well known technologies are not specifically explained to avoid ambiguous understanding of the present inventive concept. Accordingly, the exemplary embodiments are merely described below, by referring to the figures, to explain aspects of the present inventive concept. Expressions such as “at least one of,” when preceding a list of elements, modify the entire list of elements and do not modify the individual elements of the list. Unless otherwise defined, all terms used in the specification (including technical and scientific terms) may be used with meanings commonly understood by a person having ordinary knowledge in the art to which this inventive concept belongs. Further, unless explicitly defined to the contrary, the terms defined in a generally-used dictionary should be interpreted as having a meaning that is consistent with their meaning in the context of the relevant art and the present disclosure, and are not ideally or excessively interpreted. In addition, unless explicitly described to the contrary, the word “comprise” and variations such as “comprises” or “comprising”, and the word “include” and variations such as “includes” or “including”, when used in this specification, specify the presence of stated features, regions, integers, steps, operations, elements, and/or components, but do not preclude the presence or addition of one or more other features, regions, integers, steps, operations, elements, components, and/or groups thereof. Therefore, the above words will be understood to imply the inclusion of stated elements but not the exclusion of any other elements.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an,” and “the” are intended to include the plural forms as well, unless the context clearly indicates otherwise.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As stated above, unless stated to the contrary, a singular form includes a plural form.

In the drawings, the thickness of layers, films, panels, regions, etc., are exaggerated for clarity. Like reference numerals designate like elements throughout the specification.

It will be understood that when an element such as a layer, film, region, or substrate is referred to as being “on” another element, it may be directly on the other element or intervening elements may also be present. In contrast, when an element is referred to as being “directly on” another element, there are no intervening elements present.

As used herein, when a definition is not otherwise provided, the term “substituted” means that at least one hydrogen of the named compound or group is replaced by at least one substituent selected from a halogen (F, Br, Cl, or I), a C1 to C20 alkoxy group, a cyano group, an amino group, a C1 to C20 ester group, a C1 to C20 alkyl group, a C1 to C20 aryl group, a C2 to C20 alkenyl group, a C2 to C20 alkynyl group, and combinations thereof.

In an embodiment, a polarizing film having excellent light transmittance and polarizing efficiency is provided which contains a dichroic dye and a polyolefin having an ethylene group content of about 0.15 to about 3 wt % (percent by weight), the polyolefin being selected from a polyethylene-polypropylene copolymer, a mixture of polyethylene and polypropylene, a mixture of polypropylene and a polyethylene-polypropylene copolymer, and a mixture thereof.

Hereinafter, a polarizing film according to an embodiment is described referring to drawings.

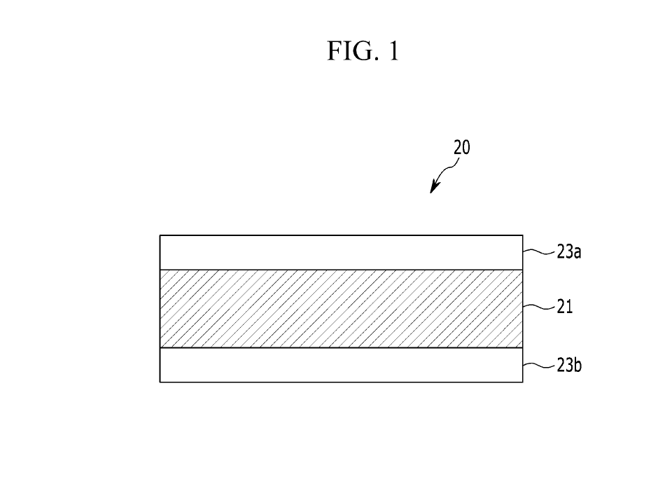

FIG. 1 is a schematic view showing a polarizing film according to an embodiment.

Referring to FIG. 1, a polarizing film 20 according to an embodiment includes a high-temperature elongation film of a polyolefin 21 and a dichroic dye 22. The polyolefin 21 and the dichroic dye 22 provide a single film having an integrated structure of the polyolefin 21 and the dichroic dye 22 through a high-temperature elongation process.

The polyolefin 21 may be a polyolefin selected from a polyethylene-polypropylene copolymer, a mixture of polyethylene and polypropylene, a mixture of polypropylene and a polyethylene-polypropylene copolymer, and a mixture thereof, wherein the content of ethylene groups of the polyolefin 21 ranges from about 0.15 to about 3 wt %, for example about 0.3 to about 2 wt %, for another example about 0.5 to about 2 wt %. When the polyolefin has the above-described content of ethylene groups, polarizing efficiency of greater than or equal to about 98.5% may be obtained, even at light transmittance of greater than or equal to about 42%.

The polyolefin 21 may have a melt flow index of about 3 g/10 min to about 11 g/10 min, for example about 3 g/10 min to about 8 g/10 min, for another example about 3 g/10 min to about 6 g/10 min. Herein, the melt flow index shows the amount of a polymer in a melt state flowing per 10 minutes, and relates to viscosity of the polymer in a melted state. In other words, as the melt flow index is lower, the polymer has higher viscosity, while as the melt flow index is higher, the polymer has lower viscosity. When the polyolefin 21 has a melt flow index within the range, properties of a final product as well as workability may be effectively improved.

When the polyolefin 21 is a mixture of polypropylene and a polyethylene-polypropylene copolymer, the polypropylene may have a melt flow index of about 3 g/10 min to about 9 g/10 min, and the polyethylene-polypropylene copolymer may have a melt flow index of about 5 g/10 min to about 11 g/10 min. When the polypropylene and the polyethylene-polypropylene copolymer have a melt flow index within the range, properties of a final product as well as workability may be effectively improved.

The polyolefin 21 may include the polypropylene and the polyethylene-polypropylene copolymer in a weight ratio of about 1:9 to about 9:1, for example about 7:3 to about 3:7, about 4:6 to about 6:4, or about 5:5. When the polypropylene and the polyethylene-polypropylene copolymer are included within these ranges, the polypropylene may be prevented from being crystallized and may have excellent mechanical strength, thus effectively improving the haze characteristics.

The polyolefin 21 may be mixed with another having similar physical optical properties. For example, the polyolefin may be mixed with a transparent having a melting point of greater than or equal to about 130° C., and a degree of crystallinity of less than or equal to about 50%, and may be mixed with, for example, a polyester such as polyethylene terephthalate (PET), polybutylene terephthalate (PBT), polyethylene terephthalate glycol (PETG), and polyethylene naphthalate (PEN).

The polyolefin 21 is elongated in a uniaxial direction. The uniaxial direction may be same as the length direction of the dichroic dye 22.

The dichroic dye 22 is dispersed into the polyolefin 21, and aligns in the elongation direction of the polyolefin 21. The dichroic dye 22 is a material that transmits one perpendicular polarization component of two perpendicular polarization components in a predetermined wavelength region.

The dichroic dye 22 may include, for example, an azo-based compound, an anthraquinone-based compound, a phthalocyanine-based compound, an azomethine-based compound, an indigoid or thioindigoid-based compound, a merocyanine-based compound, a 1,3-bis(dicyanomethylene)indan-based compound, an azulene-based compound, a quinophthalonic-based compound, a triphenodioxazine-based compound, an indolo[2,3,b]quinoxaline-based compound, an imidazo[1,2-b]-1,2,4-triazine-based compound, a tetrazine-based compound, a benzo-based compound, a naphthoquinone-based compound, or a compound having a combined molecular backbone of the foregoing compounds.

The azo-based compound may be, for example, a compound represented by Chemical Formula 1.

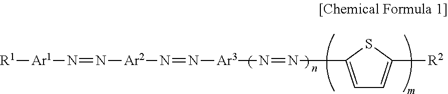

In Chemical Formula 1,

Ar¹ to Ar³ are each independently a substituted or unsubstituted C6 to C15 arylene group,

R¹ is a substituted or unsubstituted C1 to C30 aliphatic organic group, a substituted or unsubstituted C6 to C30 aromatic organic group, a substituted or unsubstituted C1 to C30 hetero aliphatic organic group, a substituted or unsubstituted C3 to C30 hetero aromatic organic group, or a combination thereof,

R² is hydrogen, a substituted or unsubstituted C1 to C30 aliphatic organic group, a substituted or unsubstituted C6 to C30 aromatic organic group, a substituted or unsubstituted C1 to C30 hetero aliphatic organic group, a substituted or unsubstituted C3 to C30 hetero aromatic organic group, a substituted or unsubstituted amino group, or a combination thereof, and

n and m are independently 0 or 1.

The dichroic dye 22 may have a decomposition temperature of greater than or equal to about 245° C. Herein, the decomposition temperature indicates a temperature at which the weight of the dichroic dye 22 decreases by about 5% relative to its initial weight.

The dichroic dye 22 may be included in an amount of about 0.1 to about 10 parts by weight, for example about 0.5 to about 5 parts by weight, based on 100 parts by weight of the polyolefin 21. When the dichroic dye is included within the range, sufficient polarization characteristics may be obtained without deteriorating transmittance of a polarizing film.

The polarizing film 20 may have a dichroic ratio of greater than or equal to about 2 to about 14, for example about 3 to about 10, at a maximum absorption wavelength (λₘₐₓ) in a visible ray region. Herein, the dichroic ratio may be calculated by dividing plane polarization absorbance in a direction perpendicular to the axis of a polymer by polarization absorbance in a horizontal direction according to the following Equation 1.

DR=Log(1/T_{⊥}/Log(1/T_{∥}) Equation 1

In Equation 1,

DR denotes a dichroic ratio of a polarizing film,

T_{∥} is light transmittance of light entering parallel to the transmissive axis of a polarizing film, and

T_{⊥} is light transmittance of light entering perpendicular to the transmissive axis of the polarizing film.

The dichroic ratio shows to what degree the dichroic dye 22 is arranged in one direction in the polarizing film 20. When the polarizing film 20 has a dichroic ratio within the range of the visible ray wavelength region, the dichroic dye 22 is arranged according to arrangement of polymer chains, improving polarization characteristics of the polarizing film 20.

The polarizing film 20 may have polarizing efficiency of greater than or equal to about 95%, for example about 95% to about 99.9%, at light transmittance of greater than or equal to about 42%. Herein, the polarizing efficiency may be obtained by the following Equation 2.

PE(%)=[(T_{∥}−T_{⊥})/(T_{∥}−T_{⊥})/(T_{∥}+T_{⊥})]^{1/2}×100 Equation 2

In Equation 2,

PE denotes polarizing efficiency,

T_{∥} is transmittance of light entering parallel to the transmissive axis of a polarizing film, and

T_{⊥} is transmittance of light entering perpendicular to the transmissive axis of the polarizing film.

The polarizing film 20 may have haze ranging from greater than 0 to less than or equal to about 5%, for example about 0.5% to about 3.5%, for another example about 0.5% to about 2.5%. When the polarizing film 20 has haze within this range, transmittance increases and excellent optical properties may be obtained.

The polarizing film 20 may have a degree of crystallinity of about 30% to about 45%, for example about 35% to about 42%. When the polyolefin has the degree of crystallinity within this range, haze may be lowered and excellent optical properties may be realized.

The polarizing film 20 is a melt-elongation film of the polyolefin 21 and the dichroic dye 22. The melt-elongation film may be obtained by melt-blending a composition for a polarizing film including a polyolefin and a dichroic dye at greater than or equal to a melting point (Tₘ) of the polyolefin. The polyolefin 21 may have a melting point (Tₘ) of less than or equal to about 300° C.

The composition for a polarizing film may include the polyolefin 21 and the dichroic dye 22, and the polyolefin 21 and the dichroic dye 22 may be respectively in a form of a solid. The composition for a polarizing film may have, for example, a solids content of greater than or equal to about 90 wt %, and for example, may not include a solvent.

The polarizing film 20 may be manufactured by melt-blending the composition for a polarizing film and elongating the same.

More specifically, the polarizing film 20 may be, for example, manufactured by a process including melt-blending the composition for a polarizing film, including the polyolefin and the dichroic dye, to prepare a melt-blend, putting the melt-blend into a mold and pressing it into a sheet, and elongating the sheet in a uniaxial direction.

The melt-blending of the composition for a polarization film may be performed at a temperature of less than or equal to about 300° C., and specifically, ranging from about 150 to about 300° C.

The sheet may be formed by putting the melt blend in the mold, and pressing it with a high pressure or discharging it in a chill roll through a T-die.

The elongation in a uniaxial direction may be performed at a temperature ranging from about 30 to about 200° C. at an elongation rate ranging from about 400% to about 1,200%. The elongation rate refers to a ratio of the length after the elongation to the length before the elongation of the sheet, and numerically expresses the elongation extent of the sheet after uniaxial elongation.

The polarizing film 20 may have a relatively thin thickness of less than or equal to about 100 micrometres (μm), for example about 10 μm to about 95 μm. When the polarizing film 20 has a thickness within the range, it may be significantly thinner than a polarizing plate requiring a protective layer such as triacetyl cellulose (TAC), and may contribute to realizing a thin display device.

The polarizing film 20 may be applied to various display devices.

The display device may be a liquid crystal display (LCD).

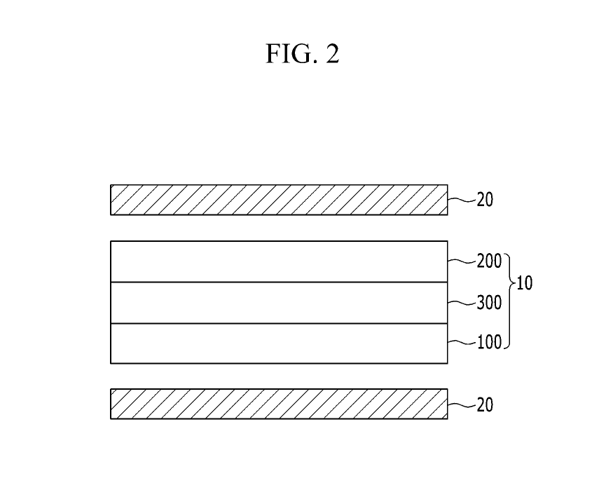

FIG. 2 is a cross-sectional view showing a liquid crystal display (LCD) according to an embodiment.

Referring to FIG. 2, the LCD according to an embodiment includes a liquid crystal display panel 10, and a polarizing film 20 disposed on both the lower part and the upper part of the liquid crystal display panel 10.

The liquid crystal display panel 10 may be a twist nematic (TN) mode panel, a patterned vertical alignment (PVA) mode panel, an in-plane switching (IPS) mode panel, an optically compensated bend (OCB) mode panel, and the like.

The liquid crystal display panel 10 includes a first display panel 100, a second display panel 200, and a liquid crystal layer 300 interposed between the first display panel 100 and the second display panel 200.

The first display plate 100 may include, for example, a thin film transistor (not shown) formed on a substrate (not shown), and a first electric field generating electrode (not shown) connected thereto. The second display plate 200 may include, for example, a color filter (not shown) formed on the substrate and a second electric field generating electrode (not shown). However, it is not limited thereto, and the color filter may be included in the first display plate 100, while both the first electric field generating electrode and the second electric field generating electrode may be disposed in the first display plate 100.

The liquid crystal layer 300 may include a plurality of liquid crystal molecules. The liquid crystal molecules may have positive or negative dielectric anisotropy. When the liquid crystal molecules have positive dielectric anisotropy, long axes thereof may be aligned substantially parallel to the surface of the first display plate 100 and the second display plate 200 when an electric field is not applied, and may be aligned substantially perpendicular to the surface of the first display plate 100 and the second display plate 200 when an electric field is applied. On the contrary, when the liquid crystal molecules have negative dielectric anisotropy, the long axes thereof may be aligned substantially perpendicular to the surface of the first display plate 100 and the second display plate 200 when an electric field is not applied, and may be aligned substantially parallel to the surface of the first display plate 100 and the second display plate 200 when an electric field is applied.

The polarizing film 20 is disposed on the outside of the liquid crystal display panel 10. Although the polarizing film 20 is shown to be disposed on the upper part and lower part of the liquid crystal display panel 10 in FIG. 2, it may be formed on either the upper part or the lower part of the liquid crystal display panel 10.

The polarizing film 20 includes a polymer and a dichroic dye that are the same as described above.

The display device may be an organic light emitting diode (OLED) display.

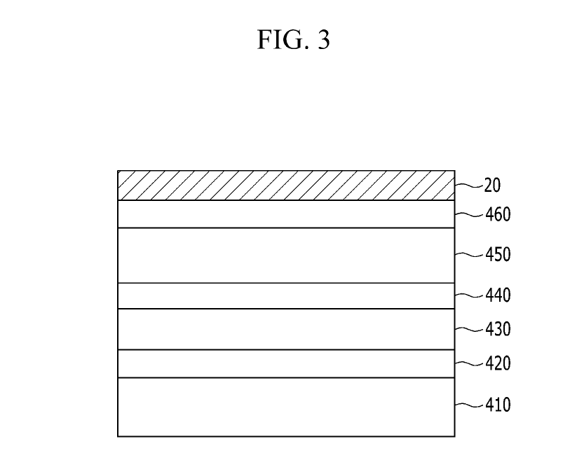

FIG. 3 is a cross-sectional view showing an organic light emitting diode (OLED) display according to an embodiment.

Referring to FIG. 3, an organic light emitting diode (OLED) display according to an embodiment includes a base substrate 410, a lower electrode 420, an organic emission layer 430, an upper electrode 440, an encapsulation substrate 450, a phase retardation film 460, and a polarizing film 20.

The base substrate 410 may be formed of glass or plastic.

Either of the lower electrode 420 or the upper electrode 440 may be an anode, while the other is a cathode. The anode is an electrode where holes are injected. It is formed of a transparent conductive material having a high work function and externally transmitting entered light, for example, indium-doped titanium oxide (ITO) or indium-doped zinc oxide (IZO). The cathode is an electrode where electrons are injected. It, is formed of a conducting material having a low work function and having no influence on an organic material, which is selected from, for example, aluminum (Al), calcium (Ca), and barium (Ba).

The organic emission layer 430 includes an organic material emitting light when a voltage is applied between the lower electrode 420 and the upper electrode 440.

An auxiliary layer (not shown) may be included between the lower electrode 420 and the organic emission layer 430 and between the upper electrode 440 and the organic emission layer 430. The auxiliary layer may include a hole transport layer, a hole injection layer, an electron injection layer, and an electron transport layer for balancing electrons and holes.

The encapsulation substrate 450 may be made of glass, metal, or a polymer. The lower electrode 420, the organic emission layer 430, and the upper electrode 440 are sealed to prevent moisture and/or oxygen from permeating.

The phase retardation film 460 may circularly polarize light passing through the polarizing film 20 and generate a phase difference, thus having an influence on reflection and absorption of the light. The phase retardation film 460 may be omitted in an embodiment.

The polarizing film 20 may be disposed at a light-emitting side. For example, the polarizing film 20 may be disposed outside of the base substrate 410 in a bottom emission type in which light emits from the base substrate 410, and outside of the encapsulation substrate 450 in a top emission type in which light emits from the encapsulation substrate 450.

The polarizing film 20 may play a role of a light absorption layer, absorbing external light, and thus prevents display characteristic deterioration due to reflection of the external light.

Hereinafter, the present disclosure is illustrated in more detail with reference to examples. However, these examples are exemplary, and the present disclosure is not limited thereto.

### Examples 1 to 7 and Comparative Example 1

### Manufacture of Polarizing Film

Mixing ratios of polypropylene (HU300, Samsung Total Petrochemicals Co., Ltd.) and a polypropylene-ethylene copolymer (RJ581, Samsung Total Petrochemicals Co., Ltd.) are controlled to prepare polyolefin combination having the percentage by weight of ethylene groups as shown in the following Table 1. The content of ethylene groups of the polyolefin combinations are confirmed by ¹³C NMR. 1 part by weight of the dichroic dyes represented by the following Chemical Formulae 1 to 4 are mixed with 100 parts by weight of the polyolefin combination. Each dichroic dye is used as follows: 0.200 parts by weight of a dichroic dye represented by the following Chemical Formula 1 (yellow, λₘₐₓ=385 nanometers (nm), dichroic ratio=7.0), 0.228 parts by weight of a dichroic dye represented by the following Chemical Formula 2 (yellow, λₘₐₓ=455 nm, dichroic ratio=6.5), 0.286 parts by weight of a dichroic dye represented by the following Chemical Formula 3 (red, λₘₐₓ=555 nm, dichroic ratio=5.1), and 0.286 parts by weight of a dichroic dye represented by the following Chemical Formula 4 (blue, λₘₐₓ=600 nm, dichroic ratio=4.5).

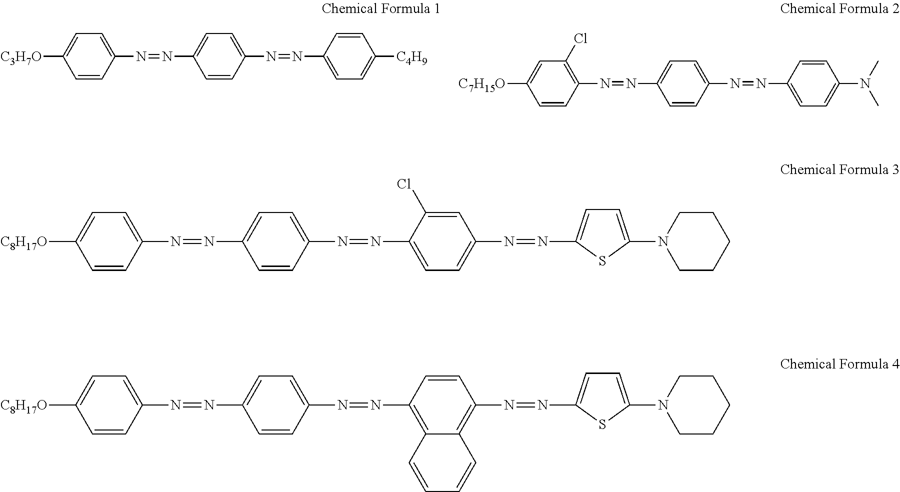

The mixtures are melt-blended at about 200° C. using an extruder (Process 11 parallel twin-screw extruder, made by ThermoFisher). Subsequently, sheets are formed using the melt-blended mixtures with an extruder (cast film extrusion line of Collin). Then, the sheets are elongated by 8 times in a uniaxial direction (tensile testing machine of Instron) at 125° C. to manufacture polarizing films.

### Examples 8 to 14 and Comparative Example 2

### Manufacture of Polarizing Film

Polarizing films are manufactured according to the same method as Examples 1 to 7 except that the elongation temperature is changed to 115° C.

### Light Transmittance and Polarizing Efficiency

Light transmittance (Ts) and polarizing efficiency (PE) of the polarizing films according to Examples 1 to 4 and Comparative Examples 1 and 2 are measured.

The light transmittance is obtained by respectively measuring light transmittance of a polarizing film of light parallel to a transmittance axis of the polarizing film and light transmittance of the polarizing film of light perpendicular to the transmittance axis of the polarizing film with a UV-VIS spectrophotometer (V-7100, JASCO).

The polarizing efficiency is obtained using the measured light transmittance.

PE(%)=[(T_{∥}−T_{⊥})/(T_{∥}+T_{⊥})]^{1/2}□100 Equation 2

In Equation 2,

PE denotes polarizing efficiency,

T_{∥} is transmittance of light entering parallel to the transmissive axis of a polarizing film, and

T_{⊥} is transmittance of light entering perpendicular to the transmissive axis of the polarizing film.

When the light transmittance is 42%, the polarizing efficiency of the polarizing film according to Examples 1 to 7 and Comparative Example 1 is shown in the following Table 1, and the polarizing efficiency of the polarizing film according to Examples 8 to 13 and Comparative Example 2 is shown in the following Table 2.

TABLE 1

| | Content of | Light | Polarizing |
|---|---|---|---|
| | ethylene group | transmittance | efficiency |
| | (wt %) | (Ts, %) | (PE, %) |
| Example 1 | 0.16 | 42.0 | 98.28 |
| Example 2 | 0.33 | 42.0 | 98.27 |
| Example 3 | 0.49 | 42.0 | 98.34 |
| Example 4 | 0.65 | 42.0 | 98.64 |
| Example 5 | 1.24 | 42.0 | 98.48 |
| Example 6 | 1.50 | 42.0 | 98.49 |
| Example 7 | 3.0 | 42.0 | 98.36 |
| Comparative | 0 | 42.0 | 98.19 |
| Example 1 | | | |

Referring to Table 1, the polarizing films according to Examples 1 to 7 show high polarizing efficiency compared with that of Comparative Example 1 when the light transmittance is 42%.

TABLE 2

| | Content of | Light | Polarizing |
|---|---|---|---|
| | ethylene groups | transmittance | efficiency |
| | (wt %) | (Ts, %) | (PE, %) |
| Example 8 | 0.16 | 42.0 | 98.29 |
| Example 9 | 0.33 | 42.0 | 98.24 |
| Example 10 | 0.49 | 42.0 | 98.32 |
| Example 11 | 0.65 | 42.0 | 98.67 |
| Example 12 | 1.24 | 42.0 | 98.58 |
| Example 13 | 1.50 | 42.0 | 98.52 |
| Example 14 | 3.0 | 42.0 | 98.32 |
| Comparative | 0 | 42.0 | 98.26 |
| Example 2 | | | |

Referring to Table 2, the polarizing films according to Examples 8 to 14 show high polarizing efficiency compared with that of Comparative Example 2 when the light transmittance is 42%.

### Migration of Dye

The initial absorption spectra (A₁) of strips of transparent tape (Scotch™ Tape, Cat. 122A, 3M) are measured using a UV-VIS Spectrophotometer (V-7100). Strips of the same type of transparent tape (Scotch™ Tape, Cat. 122A, 3M) are attached to the surfaces of the unelongated sheets prepared according to Examples 1 to 7, respectively. The sheets with tape strips attached are then allowed to stand in an 85° C. oven for 24 hours. Then, the transparent tapes are detached from the sheet surfaces, and the absorption spectra (A₂) of the tape strips are measured. A difference between these two spectra (A₂-A₁) is an absorption spectrum (A₃) of a dye transferred from the sheet to the adhesion layer on the transparent tape while allowed to stand in an oven.

The absorbance (A₃) is evaluated and compared at each maximum absorption wavelength of the dyes of Chemical Formulae 1 to 4 in the absorption spectrum, and the results are provided in Table 3.

TABLE 3

Absorbance (A₃)

| | 385 nm | 455 nm | 555 nm | 600 nm |
|---|---|---|---|---|
| Example 1 | 0.00107 | 0.00041 | 0.00036 | 0.00061 |
| Example 2 | 0.00509 | 0.00308 | 0.00206 | 0.00181 |
| Example 3 | 0.00606 | 0.00284 | 0.00044 | 0.00052 |
| Example 4 | 0.00494 | 0.00195 | 0.00062 | 0.00054 |
| Example 5 | 0.01344 | 0.00455 | 0.00099 | 0.00085 |
| Example 6 | 0.05461 | 0.01766 | 0.00351 | 0.00329 |
| Example 7 | 0.13757 | 0.04438 | 0.00681 | 0.00314 |

### Degree of Crystallinity of Polarizing Film

Degree of crystallinity of the polarizing film according to Examples 1 to 7 and Comparative Example 1 is measured using DSC (differential scanning calorimetry, about 290° C., N₂, 10° C./min). The results are shown in the following Table 4.

TABLE 4

| | Tₘ | Degree of crystallinity |
|---|---|---|
| | (° C.) | (%) |
| Example 1 | 164.1 | 44.5 |
| Example 2 | 162.9 | 43.9 |
| Example 3 | 162.0 | 42.2 |
| Example 4 | 158.9 | 41.5 |
| Example 5 | 158.3 | 39.1 |
| Example 6 | 156.2 | 36.2 |
| Example 7 | 143.8 | 32.8 |
| Comparative | 165.3 | 45.2 |
| Example 1 | | |

When a degree of crystallinity of a film is 30% to 45%, elongation behavior is improved and thus polarization characteristics may be ensured and haze characteristics are relatively improved. On the contrary, when a degree of crystallinity of a film is greater than is 45%, elongation processability may not be ensured and uniaxial alignment of a polyolefin is not favorable. These may cause deterioration of polarization characteristics and haze characteristics.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A polarizing film comprising a melt-elongation film, comprising a polyolefin selected from a polyethylene-polypropylene copolymer, a mixture of polyethylene and polypropylene, a mixture of polypropylene and a polyethylene-polypropylene copolymer, and a mixture thereof, and a dichroic dye,
wherein the polyolefin comprises about 0.15 to about 3 percent by weight of ethylene groups.

2. The polarizing film of claim 1, wherein the polyolefin comprises about 0.3 to about 2 percent by weight of ethylene groups.

3. The polarizing film of claim 1, wherein the polyolefin comprises about 0.5 to about 2 percent by weight of ethylene groups.

4. The polarizing film of claim 1, wherein the polyolefin has a melt flow index of about 3 grams per 10 minutes to 11 grams per 10 minutes.

5. The polarizing film of claim 1, wherein the polyolefin is a mixture of polypropylene and a polyethylene-polypropylene copolymer,
the polypropylene has a melt flow index of about 3 grams per 10 minutes to about 9 grams per 10 minutes, and
the polyethylene-polypropylene copolymer has a melt flow index of about 5 grams per 10 minutes to about 11 grams per 10 minutes.

6. The polarizing film of claim 1, wherein the polyolefin comprises polypropylene and polyethylene-polypropylene copolymer in a weight ratio of about 1:9 to about 9:1.

7. The polarizing film of claim 1, wherein the dichroic dye is dispersed in the polyolefin, and the polyolefin is elongated in a uniaxial direction at an elongation rate of about 400% to about 1,200%.

8. The polarizing film of claim 1, wherein the dichroic dye is present in an amount of about 0.1 to about 10 parts by weight based on 100 parts by weight of the polyolefin.

9. The polarizing film of claim 8, wherein the dichroic dye is present in an amount of about 0.5 to about 5 parts by weight based on 100 parts by weight of the polyolefin.

10. The polarizing film of claim 1, wherein the polarizing film has a haze ranging from greater than 0 to less than or equal to about 5%.

11. The polarizing film of claim 10, wherein the polarizing film has a haze of about 0.5% to about 3.5%.

12. The polarizing film of claim 11, wherein the polarizing film has a haze of about 0.5% to about 2.5%.

13. The polarizing film of claim 13, wherein the polarizing film has a degree of crystallinity of about 30% to about 45%.

14. The polarizing film of claim 13, wherein the polarizing film has a degree of crystallinity of about 35% to about 42%.

15. The polarizing film of claim 1, wherein the polarizing film has polarizing efficiency of greater than or equal to about 98% at light transmittance of greater than or equal to about 42%.

16. A display device comprising the polarizing film of claim 1.

17. A composition for a polarizing film comprising a polyolefin selected from a polyethylene-polypropylene copolymer, a mixture of polyethylene and polypropylene, a mixture of polypropylene and a polyethylene-polypropylene copolymer, and a mixture thereof, and a dichroic dye,
wherein the polyolefin comprises about 0.15 to about 3 percent by weight of ethylene groups.

18. The composition for a polarizing film of claim 17, wherein the polyolefin comprises about 0.3 to about 2 percent by weight of ethylene groups.

19. The composition for a polarizing film of claim 17, which has a solids content of greater than or equal to about 90 percent by weight.

20. The composition for a polarizing film of claim 17, which does not comprise a solvent.
